(19) United States
(12) Patent Application Publication
(10) Pub. No.: US 2005/0262355 A1
(43) Pub. Date: Nov. 24, 2005

(54) Method of providing a signing key for digitally signing verifying or encrypting data and mobile terminal

(75) Inventors: Franz-Josef Banet, Kreuzweg (DE); Matthias Duspiva, Wasserbachstr (DE); Stephen Rupp, Trollingerweg (DE); Hans Josef Stegers, Mirander Str. (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/126,265

(22) Filed: May 11, 2005

(30) Foreign Application Priority Data
May 19, 2004 (EP) 04291293.1

(51) Int. Cl. H04L 9/00

(52) U.S. Cl. 713/180

(57) ABSTRACT

The present invention relates to a method of providing a key, in particular for digitally signing, verifying or encrypting data to be exchanged between a first party and a second party, comprising steps of transmitting (100) an identification code, which is uniquely identifying said first party, from said first party to a gateway (CCBS), verifying (110) said identification code by said gateway (CCBS) by using (111) an authentication server (AUC), and creating (120) a signing key. Said method is characterized by providing (130) said signing key to said first party and/or to said second party. A transmission of said signing key via a secure communications channel, in particular via a GSM-based communications infrastructure, improves the security of payment transactions.

The present invention further relates to a mobile terminal (1) and a gateway (CCBS).

### TECHNICAL FIELD

The present invention relates to a method of providing a key, in particular for digitally signing, verifying or encrypting data to be exchanged between a first party and a second party, comprising the steps of transmitting an identification code, which is uniquely identifying said first party, from said first party to a gateway, verifying said identification code by said gateway by using an authentication server, and creating a signing key.

The present invention further relates to a mobile terminal and a gateway.

The invention is based on a priority application, EP 04291293.1, which is hereby incorporated by reference.

### BACKGROUND OF THE INVENTION

Prior art methods of providing signing keys for digitally signing data often rely on long-term signing keys which are not very secure since there is no possibility to dynamically alter said signing keys.

There are also methods which provide for dynamic creation/selection of signing keys, but these methods usually employ extra software and/or hardware such as personalized chip cards.

Furthermore, in many cases a contract with a trust center is required.

### SUMMARY OF THE INVENTION

Hence it is an object of the present invention to provide an improved method of providing a signing key as well as an improved mobile terminal and an improved gateway.

Concerning the method of providing a signing key, said object is achieved by providing said signing key to said first party and/or to said second party.

Although in the further description the term “signing key” is used, it is to be understood that said signing key describes a digital key in general and that said signing key may be used for verifying or encrypting data, in particular transaction data as well as it may be used for signing. Therefore, the subject matter of the present invention is not limited to the possibility of signing data.

The steps of transmitting and verifying an identification code and creating a signing key are for example implemented in the authentication mechanisms of GSM (global system for mobile communications) communication systems, wherein e.g. an international mobile station identity (IMSI) is used as said identification code.

The GSM authentication mechanisms are, inter alia, based on so-called A3- and A8-algorithms the latter of which is also called “voice privacy algorithm” since it is used to encipher voice data exchanged between a mobile GSM terminal and a GSM base transceiver station (BTS).

Said A8-algorithm e.g. yields a 64-bit number also denoted as ciphering key Kc. According to the present invention, this ciphering key is provided to said first party which e.g. uses a mobile terminal such as a cellular phone or a PDA (personal digital assistent) or a portable personal computer with a wireless GSM interface, and which may need a signing key in order to authenticate a transaction with said second party. The first party can use the ciphering key Kc obtained by the A8-algorithm of the GSM system as such a signing key.

In order to be able to verify a digital signature of the first party so obtained, said second party is also provided with said ciphering key, or signing key, respectively.

By using a signing key, which is according to the present invention derived from a ciphering key of the GSM system, it is possible for the second party to verify the integrity of signed data and to authenticate the first party. The second party may e.g. be an online service provider offering goods and/or services via the Internet and the first party may e.g. be a customer of said second party.

In particular, according to the method of the present invention, there is no need for additional software or hardware or even a contract with a trust center because the inventive method is based on an existing authentication mechanism of the GSM standard, which improves flexibility.

According to an embodiment of the present invention, a further signing key is created which depends on said signing key but which is not identical to the ciphering key of the A8-algorithm.

To improve the inventive method's security and increase the available code space, it is possible to create said further signing key depending on further data which is common to said first party and an authentication server but which is not available to the public. Said further data may e.g. be derived from any form of subscription data of the first party such as an address, further personal data or the like.

The creation of the further signing key may e.g. be performed by using state-of-the-art signing algorithms for use with symmetric keys such as the message authentication code or keyed hashing for message authentication, cf. e.g. RFC 2104 (Internet requests for comments).

According to another advantageous embodiment of the present invention, a long-life signing key is provided, which may be used for a plurality of signing and authenticating transactions. In order to enable a reuse of such a long-life signing key, another variant of the inventive method provides a step of storing said long-life signing keys.

Yet a further embodiment of the present invention is characterized by providing a plurality of signing keys, each of which is preferably valid for a single use only.

The advantages of providing a plurality of signing keys are obvious: only a single GSM authentication process is required which yields according to the present invention a plurality of signing keys and thus avoids further GSM authentications as long as there are signing keys left to use.

Said signing keys may be stored to a mobile terminal of the first party and to said gateway, from which they may be obtained by the second party later on. The storage of signing keys accelerates future signing processes and ensures the possibility of signing even if GSM functionality is (temporarily) not available which may be due to locking network coverage.

Another advantageous embodiment of the present invention is characterized by providing an extra key or a plurality of extra keys which can be used to encipher said signing key(s). Said extra key(s) are transmitted and stored to a mobile terminal of the first party and to said gateway, which enables secure communication by means of enciphering said signing key(s) even if GSM functionality is not given.

By enciphering said signing key(s) with said extra key(s), it is possible to establish a secure transmission of signing keys between the mobile terminal of the first party and the gateway while using any kind of ad hoc network based on DECT (digital enhanced cordless telecommunications), bluetooth and IrDA systems instead of GSM communications.

According to a further advantageous embodiment of the present invention, said signing key is used for enciphering a communication between said first party and said second party which enables to also use ad hoc networks such as bluetooth for transmitting confidential signing data.

Another embodiment of the present invention proposes verifying the creditworthiness of said first party, which contributes to avoiding unnecessary GSM authentications. Said verification can e.g. be performed in said gateway before initiating a GSM authentication that is to be used for a future signing process. If the creditworthiness of said first party does e.g. not meet a predetermined criterion, no further transactions are permitted by said gateway. In particular, a GSM authentication for e.g. obtaining a signing key is unnecessary.

A further very advantageous embodiment of the present invention is characterized by transmitting said signing key(s) and/or said extra key(s) via a short message service (SMS) of a mobile communications infrastructure and/or via another secure connection, to said first party and/or to said second party. By doing so, the risk of the signing key being intercepted by an unauthorized party is minimized. It is obvious that a multimedia message service (MMS) or the like can also be used for securely transmitting said signing key(s) and/or said extra key(s).

The object of the present invention is furthermore achieved by a mobile terminal capable of performing the following steps: transmitting an identification code, which is uniquely identifying said mobile terminal and/or a first party using said communications terminal, to a second party and/or a gateway; receiving an authentication request from said gateway; creating an authentication response; transmitting said authentication response to said gateway; receiving and/or creating and/or storing at least one signing key and a gateway. The mobile terminal uses the signing key for authorizing transactions, in particular payment transactions, and/or for accessing single-sign-on services.

Furthermore, this object is achieved by a gateway capable of performing the following steps: receiving an identification code, which is uniquely identifying a mobile terminal and/or a first party using said mobile terminal; verifying said identification code by using an authentication server; and creating at least one signing key, providing said mobile terminal and/or said first party and/or said second party with said signing key(s) and/or storing said signing key(s).

### BRIEF DESCRIPTION OF THE DRAWINGS

Further advantages and details of the invention are presented in the following detailed description with reference to the drawings, wherein

FIG. 1a depicts a first embodiment of the method ccording to the present invention,

FIG. 1b depicts a second embodiment of the method according to the present invention,

FIG. 1c depicts a third embodiment of the method according to the present invention, and

FIG. 2 depicts a fourth embodiment of the method according to the present invention.

### DETAILED DESCRIPTION OF THE INVENTION

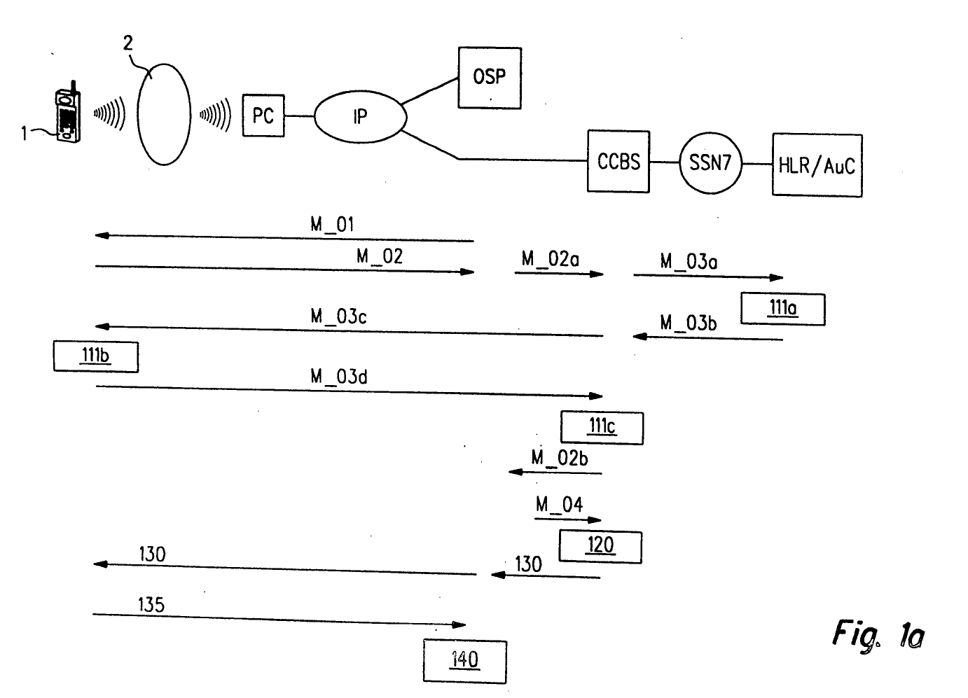

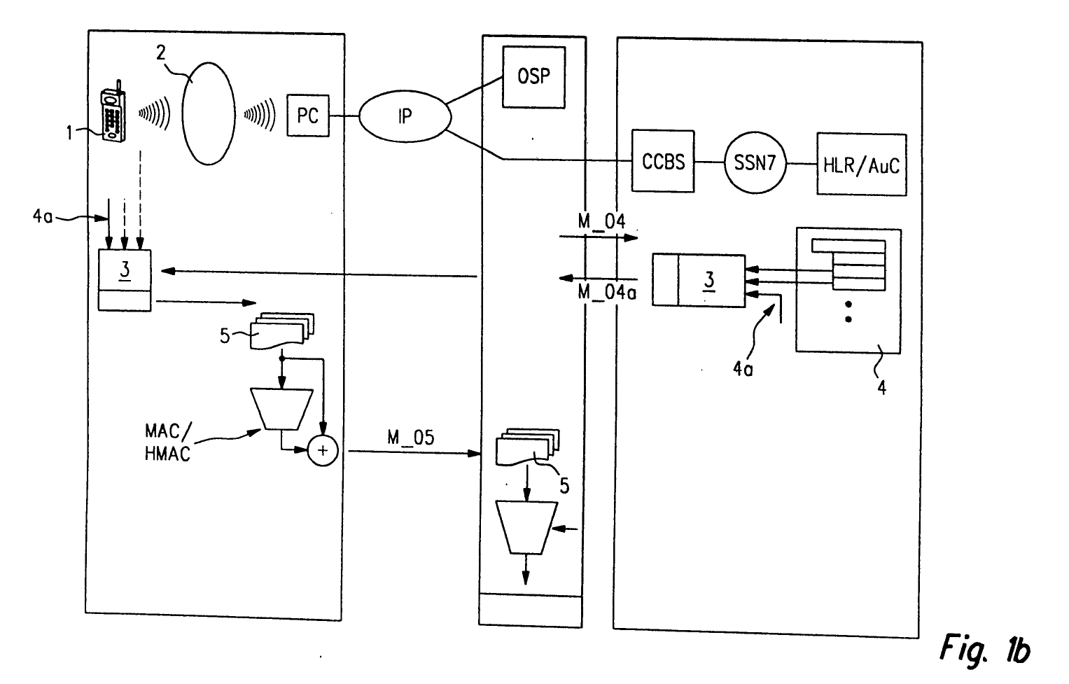

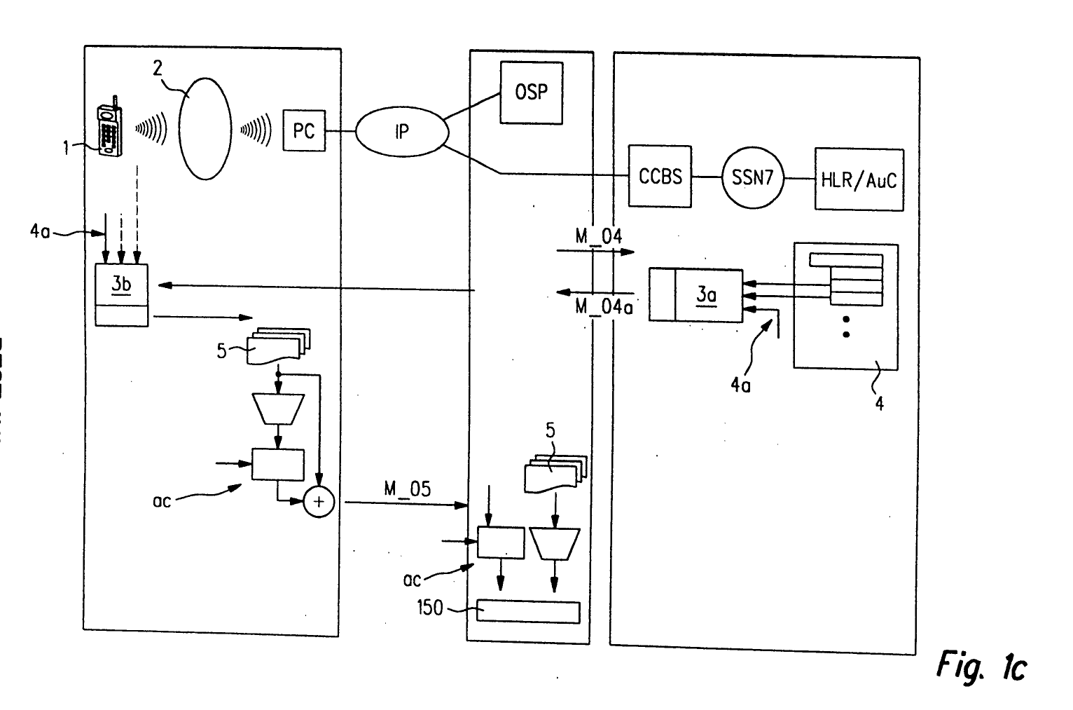

FIG. 1a shows a mobile terminal 1 of a first contracting party which contacts an online service provider OSP constituting a second contracting party.

As can be gathered from FIG. 1a, a connection between said mobile terminal 1 and said online service provider OSP is established firstly via a wireless access network 2, which may be an ad hoc network based on e.g. DECT, bluetooth or IrDA, and secondly via a personal computer PC, which in turn is connected to said online service provider via the Internet IP. The mobile terminal 1 and the personal computer PC are both equipped with a corresponding DECT, bluetooth or IrDA interface.

Instead of said personal computer PC any other type of access point such as e.g. a WLAN (Wireless Local Area Network) router or the like may be used.

Said first party desires to use an online service offered by said online service provider OSP and is thus required to authenticate itself to said online service provider OSP.

For this purpose, the online service provider OSP issues an authentication request M_01 to said mobile terminal 1 of said first party, which responds with an authentication response M_02 that comprises an identification code that is uniquely identifying said first party or its mobile terminal 1, respectively.

The identification code transmitted from the mobile terminal 1 to the online service provider OSP is a so-called international mobile subscriber identity (IMSI), which is stored to a SIM (subscriber identity module)-card that is comprised within the mobile terminal 1.

Said identification code is forwarded via message M_02a from said online service provider OSP to a customer care and billing system CCBS from which it is again forwarded to an authentication server AuC in form of a GSM standard authentication request M_03a.

Due to its position in the transmission configuration depicted in FIG. 1a, said customer care and billing system CCBS can also be understood as a gateway which manages e.g. contacting said authentication server AuC.

Said authentication server AuC may e.g. be comprised in a home location register (HLR) of a network operator a mobile network of which the first party is subscribed to. The authentication server AuC is connected to said customer care and billing system CCBS via a signalling system SSN7.

Upon receiving the GSM standard authentication request M_03a from said customer care and billing system CCBS, said authentication server AuC performs a GSM standard authentication, step 111a of FIG. 1a, which involves generating a so-called triplet comprising
a random number,
a signed response, and
a ciphering key,
   which is sent back to said customer care and billing system CCBS by means of message M_03b.

The random number of said triplet is forwarded to the mobile terminal 1 by means of message M_03c, which in step 111b continues the GSM standard authentication based on the known A3- and A8-algorithms of the GSM standard (cf. ETSI-GSM Technical Specification GSM 03.20, Version 3.3.2). This yields a so-called challenge response, i.e. the random number digitally signed with the same ciphering key used as in the authentication server AuC. Said challenge response is returned to said customer care and billing system CCBS via message M_03d.

In step 111c, said signed response from the authentication server AuC and said challenge response from said mobile terminal 1 are tested for identity within said customer care and billing system CCBS. If they are identical, the first party using said mobile terminal 1 has successfully authenticated itself to the customer care and billing system CCBS.

A positive authentication result M_02b is thereupon transmitted to the online service provider OSP which requests a signing key from the customer care and billing system CCBS via the message M_04, which also contains the international mobile subscriber identity (IMSI) of said mobile terminal 1.

Said signing key may be the ciphering key of the above mentioned triplet. In this case, creating a signing key is not necessary. Otherwise, a signing key is generated in step 120 of FIG. 1a and is provided to both the online service provider OSP and the mobile terminal 1, which is denoted by the arrows 130 in FIG. 1a.

Providing 130 said signing key is performed via a secure connection, which in case of the transmission to said online service provider may be a secured session over the Internet IP. Regarding the transmission to said mobile terminal 1, a secure wireless transmission is performed by using a short message service (SMS) of a GSM network.

Additionally, said signing key may itself be enciphered for the transmission to said mobile terminal 1 by using a suitable key which can be comprised of secret data that is only shared by said customer care and billing system CCBS and said first party 1, so as to increase transmission security of said signing key.

Now both the online service provider OSP and the first party with its mobile terminal 1, possess a signing key which can be used to digitally sign data.

For instance, the first party can exchange any unsigned/unciphered contracting parameters 135 such as a price or something else with the second party, i.e. the online service provider OSP, and additionally, both of them digitally sign said parameters. Then the first party also transmits said signed parameters to the second party, which simply compares its own signed parameters with the signed parameters received from the first party. If both sets of signed parameters are identical, integrity of parameters as well as the identity of said first party is ensured, and a transaction such as a contract or a payment 140 and the like may be performed.

Thus by using existing GSM authentication measures according to the messages M_03a, M_03b, M_03c, M_03d, it is possible to provide signing keys to the first and second party without extra hardware or software and especially without any contract to an (external) trust center.

FIG. 1b shows a second embodiment of the present invention, which assumes a positive GSM authentication result according to step 111c of FIG. 1a and does not show the messages M_03a, M_03b, M_03c, M_03d which are part of the GSM standard authentication process described above.

After successful completion of the GSM authentication, cf. to message M_02b of FIG. 1a, the online service provider OSP requests a signing key from the customer care and billing system CCBS via the message M_04 (FIGS. 1b, 1a), which also contains the international mobile subscriber identity (IMSI) of the mobile terminal 1, the latter one having been received by the online service provider OSP in the above described manner.

By sending the mobile terminal's IMSI to said customer care and billing system CCBS, an appropriate, individual key generation for said mobile terminal 1 is enabled. Otherwise within said CCBS it would be not clear for which mobile terminal a key generation is to be initiated, which is critical since said signing keys are specific to the corresponding mobile terminal 1 or its IMSI or the like.

The customer care and billing system CCBS has a key generator 3 for creating a signing key based on input data such as the international mobile subscriber identity (IMSI) of the mobile terminal 1, a session specific random number that has already been exchanged during GSM standard authentication, cf. message M_03b of FIG. 1a, a ciphering key and/or other secret data shared only by the first party and the authentication server AuC. Said input data is provided by a database 4 and the input is symbolized in FIG. 1b by the arrows 4a.

The signing key is created within said key generator 3 and then returned to the online service provider OSP by message M_04a.

The same key generator 3 is located within said mobile terminal 1, in particular on a SIM (subscriber identity module)-card within the mobile terminal 1, and the aforementioned signing key is also generated within said mobile terminal 1, based on the same input 4a.

After creation of said signing key within said mobile terminal 1, a standardized signing algorithm such as a message authentication code MAC or a keyed hashing for message authentication HMAC (cf. RFC 2104, Internet requests for comments) is applied to document 5 and the document 5 is sent to the online service provider OSP together with the so signed document 5 via message M_05.

Upon receiving said message M_05, the online service provider OSP verifies the document 5 and the signed document by applying a standardized signing algorithm such as a message authentication code MAC or a keyed hashing for message authentication HMAC, to said document 5. It is evident that both said mobile terminal 1 and said online service provider OSP must use the same standardized signing algorithms MAC/HMAC.

If the signed version of document 5 created by the online service provider OSP is identical to the signed version of document 5 created by said mobile terminal 1, the identity of the mobile terminal 1 and the integrity of the document 5 is proofed.

A further embodiment of the present invention is shown in FIG. 1c. In contrast to FIG. 1b, an asymmetric signing process is employed. For this purpose, a public key generator 3a, which may e.g. be comprised within said customer care and billing system CCBS, is fed with input data 4a from a database 4 as already explained above to generate a public signing key sent to the online service provider OSP via message M_04a on request M_04.

The mobile terminal 1 comprises a private key generator 3b that generates a private signing key which is used by an asymmetric ciphering algorithm ac to create a signature which is sent to the online service provider OSP together with the document 5 by means of message M_05.

The online service provider OSP then verifies the identity of the mobile terminal 1 and the integrity of said document 5 by employing prior art asymmetric ciphering and deciphering algorithms in step 150.

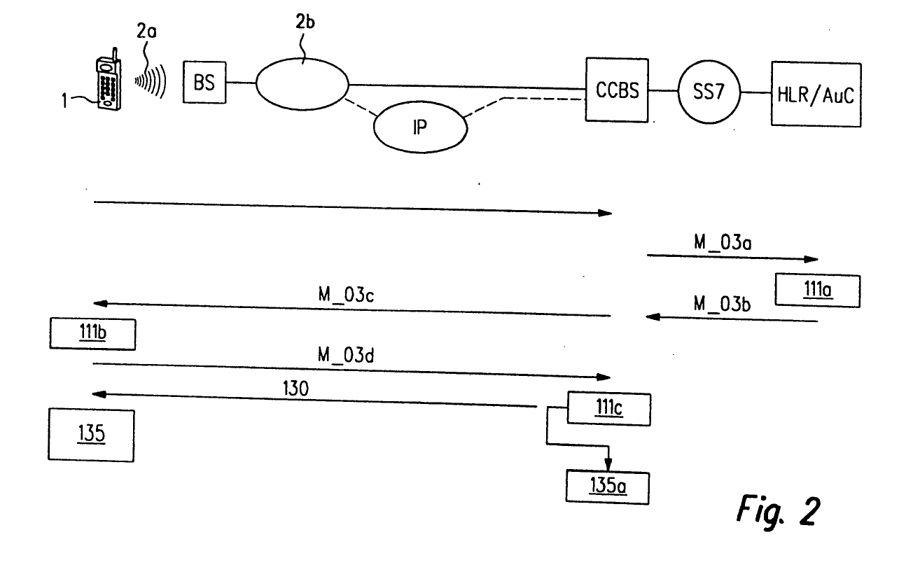

FIG. 2 shows a further embodiment of the method according to the present invention, in which a GSM standard authentication as already explained with reference to FIGS. 1a, 1b, 1c is performed first.

After testing said signed response from the authentication server AuC and said challenge response from said mobile terminal 1 for identity within said customer care and billing system CCBS in step 111c, a plurality of signing keys is generated within said customer care and billing system CCBS and is provided to the mobile terminal 1 in step 130. The mobile terminal 1 stores said plurality of signing keys in step 135, and said signing keys are also stored to the customer care and billing system CCBS which is done in step 135a.

The storage of signing keys accelerates future signing processes and ensures the possibility of signing even if GSM functionality or any other communications channel that is usually used for securely transmitting signing keys particularly to said mobile terminal 1 is (temporarily) not available which may e.g. be due to lacking network coverage.

Yet a further variant of the present invention proposes to create at least one long-life token after a successful GSM standard authentication.

Both variants reduce a network load of the networks used for authentication, since a new authentication is only required if the long-life signing key has expired or each signing key of the plurality of signing keys has been used.

Furthermore, if a long-life signing key is still valid or if there are stored signing keys available in the mobile terminal 1, a user-transparent authentication can be performed, since accessing a stored signing key does not require user interaction. In this case, a mobile terminal comprising the stored signing keys should be password protected.

Said signing key(s) may generally be created/obtained by a ciphering key of the GSM standard authentication process. Additionally, secret data shared only by said first party and an authentication server AuC may be used to create a further signing key.

Providing an extra key or a plurality of extra keys which can be used to encipher said signing key(s) is also possible with the method according to the present invention. Said extra key(s) are transmitted and stored to the mobile terminal 1 of the first party and to said gateway CCBS, which enables a secure transmission of said signing key(s) even if GSM functionality is not given.

By enciphering said signing key(s) with said extra key(s), it is possible to establish a secure transmission of signing keys between the mobile terminal 1 of the first party and the gateway CCBS while using any kind of ad hoc network based on DECT (digital enhanced cordless telecommunications), bluetooth and IrDA systems instead of GSM communications.

Generally, any type of transaction requiring user authentication or verification of transaction data can be improved by the present invention. Especially payment transactions can advantageously be simplified while at the same time increasing transaction security.

It is also possible to use the signing keys obtained by the method according to the present invention for accessing so-called single-sign-on services. Single-sign-on services provide for a centralized authentication process by means of a single authentication entity also known as “identity provider” which performs user authentication for a plurality of service providers which define a “circle of trust”. After such an authentication, the identified user can contract with any service provider of said circle of trust without being asked to re-authenticate. Single-sign-on services are e.g. provided by a so-called Liberty Alliance Project (cf. website http://www.projectliberty.org/).

Generally, prior to initiating a GSM standard authentication (M_03a, . . . , FIG. 1a) the creditworthiness of said first party can be checked by said customer care and billing system CCBS. This eliminates the need to perform said GSM standard authentication if the first party has a poor creditworthiness and thus reduces a network load.

In those cases, in which said signing key is transmitted from said customer care and billing system CCBS to said mobile terminal 1 via a short message (SMS), the customer care and billing system CCBS is not required to pass the corresponding short message to a short message service center (SMSC). Instead, the customer care and billing system CCBS can request an address, in particular the so-called MSC_ID, of a serving mobile switching center (MSC) of said GSM network, from a home location register (HLR) and transmit the short message to the mobile terminal 1 directly. This prevents delays that may be caused by a processing of said short message within said short message service center (SMSC).

The method according to the present invention furthermore provides an added value for network operators since they can offer secure and easy transactions to users for payments e.g. at supermarkets, authentication of bidders at online auctions and the like.

It is also possible to provide payment applications which are implemented within said mobile terminal 1 in addition to a regular firmware of said devices. Said payment applications can be used to control the above explained transaction processes and may have direct access to a GSM interface of said mobile terminal 1.

A further advantage of the present invention is the fact that users of a corresponding mobile terminal 1 can spontaneously make use of said authentication according to the present invention to take part in raffles or auctions which are for instance presented to attract people to marketing events. A separate, i.e. non-electronic, verification of an identity of such people is not necessary because of the authentication according to the present invention. Informing bidders and/or winners of said raffle can as well be conducted by e.g. said customer care and billing system CCBS in a sophisticated way via short messages (SMS), phone calls or electronic mail.

As already stated above, the subject matter of the present invention is not limited to the possibility of signing data.

It is also possible to use said signing key for (digitally) verifying or encrypting data as well, which depends on a respective application and the type of transaction provided. For instance, said signing key may be used to sign and/or encrypt and/or verify contracts, price lists, orders, transaction numbers used for electronic banking and the like.

According to a further embodiment of the present invention, if said online service provider OSP and said customer care and billing system CCBS both are comprised within a circle of trust administered e.g. by the Liberty Alliance, said online service provider OSP may initiate an authentication by said customer care and billing system CCBS without requesting an IMSI from said first party, because in this case said customer care and billing system CCBS itself issues an authentication request (cf. M_01, FIG. 1a). In this case, the customer care and billing system CCBS plays the role of an identity provider (IDP), too.

To further improve security, the customer care and billing system may protect an identity of said first party by using existing parameters such as a temporary mobile station identity (TMSI) and/or a location area index (LAI), cf. C. Lüders: Mobilfunksysteme, Vogel Verlag, Würzburg, 2001, p. 140.

It is also possible to use separate anonymizing services that work independent of methods provided by communications networks.

1. Method of providing a key, in particular for digitally signing verifying or encrypting data to be exchanged between a first party and a second party, comprising the following steps:
transmitting an identification code, which is uniquely identifying said first party, from said first party to a gateway,
verifying said identification code by said gateway by using an authentication server,
creating a signing key,
wherein said method provides said signing key to said first party and/or to said second party.

2. Method according to claim 1, wherein said method creates a further signing key which depends on said signing key and/or further data shared by said first party and said authentication server.

3. Method according to claim 1, wherein said method provides a long-life signing key.

4. Method according to claim 1, wherein said method provides a plurality of signing keys.

5. Method according to claim 3, wherein said method provides an extra key or a plurality of extra keys for enciphering said signing key(s).

6. Method according to claim 3, wherein said method stores said long-life signing key and/or said plurality of signing keys and/or said extra key and/or said plurality of extra keys.

7. Method according to claim 1, wherein said method transmits said signing key(s) and/or said extra key(s) via a short message service (SMS) of a mobile communications infrastructure and/or via a/another secure connection, to said first party and/or to said second party.

8. Method according to claim 1, wherein said method uses said signing key for enciphering a communication between said first party and said second party.

9. Method according to claim 1, wherein said method uses said signing key(s) and/or said extra key(s) for authorizing transactions, in particular payment transactions, and/or for accessing single-sign-on services.

10. Method according to claim 1, wherein said method verifies the creditworthiness of said first party.

11. Method according to claim 1, wherein said method uses a ciphering key obtained by using an A8-algorithm according to the GSM standard as said signing key.

12. Mobile terminal capable of performing the following steps:
transmitting an identification code, which is uniquely identifying said mobile terminal and/or a first party using said communications terminal, to a second party and/or a gateway,
receiving an authentication request from said gateway,
creating an authentication response,
transmitting said authentication response to said gateway,
receiving and/or creating and/or storing at least one signing key.

13. Mobile terminal according to claim 12, wherein said mobile terminal uses said signing key for authorizing transactions, in particular payment transactions, and/or for accessing single-sign-on services.

14. Gateway capable of performing the following steps:
receiving an identification code, which is uniquely identifying a mobile terminal and/or a first party using said mobile terminal,
verifying said identification code by using an authentication server,
creating at least one signing key, providing said mobile terminal and/or said first party and/or said second party with said signing key(s) and/or storing said signing key(s).
